(19) United States
(12) Patent Application Publication
(10) Pub. No.: US 2013/0216727 A1
(43) Pub. Date: Aug. 22, 2013

(54) Hard Coat Film, Coating Liquid For Forming A Hard Coat Layer, Polarizing Plate And Transmission Type LCD

(71) Applicant: Toppan Printing Co., Ltd., (US)

(72) Inventor: Yoshinari Tomo, Tokyo (JP)

(73) Assignee: TOPPAN PRINTING CO., LTD., Tokyo (JP)

(21) Appl. No.: 13/846,744

(22) Filed: Mar. 18, 2013

Related U.S. Application Data
(63) Continuation of application No. 12/476,257, filed on Jun. 1, 2009.

(30) Foreign Application Priority Data
Jun. 2, 2008 (JP) 2008-144205

(51) Int. Cl. C09D 5/16

(52) U.S. Cl. CPC C09D 5/1606
USPC 427/503; 427/496

(57) ABSTRACT

The present invention provides a hard coat film and a coating liquid for forming a hard coat layer having excellent antifouling properties with low costs. It is a feature of the present invention that the coating liquid for forming a hard coat layer has at least an ionizing radiation curable material, a fluorosurfactant or a silicone surfactant, and a solvent and a weight mean solubility δ of the component excluding the solvent component and the fluorosurfactant or the silicone surfactant component from the coating liquid for forming a hard coat layer is 21.5 or more. In addition, it is also a feature of the present invention that the weight mean solubility δ of the component excluding the fluorosurfactant or the silicone surfactant component from the coating liquid for forming a hard coat layer is 19.0 or more.

### CROSS REFERENCE TO RELATED APPLICATION

This application is a continuation of application Ser. No. 12/476,257 filed on Jun. 1, 2009 which is based on and claims the benefit of priority from the Japanese Patent Application number 2008-144205, filed on Jun. 2, 2008. The entire contents of both applications, including the drawings, are incorporated herein by reference.

### BACKGROUND OF THE INVENTION

1. Field of the Invention

The present invention relates to a coating liquid for forming a hard coat layer. In particular, the present invention relates to a coating liquid for forming a hard coat layer which has not only abrasion resistance but also antifouling properties. A number of hard coated products which have abrasion resistance and antifouling properties are obtained easily with low cost by providing various products with a hard coat layer using the coating liquid for forming a hard coat layer of the present invention. For example, by forming the hard coat layer included in the present invention on a transparent film or a transparent plate, a hard coat film or a hard coating treated plastic plate having a high level of abrasion resistance and antifouling properties is obtained and can be applied on a display such as an LCD, a PDP display, an FED or an electroluminescence display etc. or a touch panel preferably. In addition, it is possible to provide surfaces of a recording media such as CD and DVD etc., a decorative plate or a glass plate with the abrasion resistance and antifouling properties by arranging a hard coat layer using the coating liquid for forming a hard coat layer of the present invention.

2. Description of the Related Art

In recent years, a variety of glass products are being replaced by corresponding plastic products since plastics have an advantage of the capability of being cast into a variety of shapes as well as saving weight. As the surfaces of such products tend to be scratched and damaged, a hard coat layer is often arranged on these products in order to provide them with a surface hardness and abrasion resistance.

In addition, even on glass products which have not yet been replaced with the plastic products, the use of a plastic film for the purpose of shatter resistance is increasing in case the glass is broken. It is widely spread that a hard coat layer is formed on the surface of such a plastic film to improve surface hardness and used as a display surface such as an LCD, a PDP display, an FED and an electroluminescence display, and a touch panel.

The hard coat layer is often produced by coating on a substrate an ionizing radiation curing type acrylic resin which has a higher hardness than the substrate. Having 27-45 mJ/m² of relatively high surface energy, however, the cured material of the ionizing radiation curing type acrylic resin has a problem of easily adsorbing dusts and smears, which are hardly removed by wiping, resulting in a decrease in visibility.
<Patent Document 1> JP-A-2003-335984

### SUMMARY OF THE INVENTION

The present invention provides a coating liquid for forming a hard coat layer which has excellent antifouling properties, and a resultant hard coat film with a low cost.

In order to provide such a coating liquid and a hard coat film, a first aspect of the present invention is a coating liquid for forming a hard coat layer having at least a fluorosurfactant or a silicone surfactant, a solvent, and a first component including an ionizing radiation curable material, a weight mean solubility δ of the first component being 21.5 or more.

In addition, a second aspect of the present invention is the coating liquid for forming a hard coat layer according to the first aspect of the present invention, further comprising a second component that includes the first component and the solvent, wherein a weight mean solubility δ of the second component is 19.0 or more.

In addition, a third aspect of the present invention is the coating liquid for forming a hard coat layer according to the first aspect of the present invention, wherein the fluorosurfactant or the silicone surfactant is a cross-linking surfactant.

In addition, a fourth aspect of the present invention is the coating liquid for forming a hard coat layer according to the first aspect of the present invention, wherein 0.005-1 parts by weight of the fluorosurfactant or the silicone surfactant component is included in 100 parts by weight of the first component and the fluorosurfactant or silicone surfactant.

In addition, a fifth aspect of the present invention is a hard coat film having a hard coat layer arranged on at least one surface of a film substrate, the hard coat layer being formed by coating the coating liquid for forming a hard coat layer according to the first aspect of the present invention on the film substrate to form a coated layer, drying the coated layer, and exposing the coated layer to ionizing radiation so that the coated layer cures.

In addition, a sixth aspect of the present invention is the hard coat film according to the fifth aspect of the present invention, wherein a contact angle of water is more than or equal to 90°, a contact angle of diiodemethane is more than or equal to 65°, and a contact angle of hexadecane is more than or equal to 35° on the surface of the hard coat layer of the hard coat film.

In addition, a seventh aspect of the present invention is the hard coat film according to the fifth aspect of the present invention, wherein a thickness of the hard coat layer is in the range of 4-25 μm.

In addition, an eighth aspect of the present invention is a polarizing plate which includes the hard coat film according to the fifth aspect of the present invention, wherein the hard coat layer of the hard coat film is arranged on one surface of the film substrate and a polarizing layer which has another film substrate thereon is arranged on the other surface of the film substrate.

In addition, a ninth aspect of the present invention is a transmission type LCD which has the polarizing plate according to the eighth aspect of the present invention, a liquid crystal cell, a second polarizing plate, and a back light unit in the order of this description so that the hard coat layer is arranged as the outermost surface.

A hard coat layer which had excellent antifouling properties was formed with a low cost by using such a coating liquid for forming a hard coat layer described above. Moreover, a hard coat film which had excellent antifouling properties was fabricated with low cost by forming a hard coat layer on a film substrate by using the coating liquid for forming a hard coat layer of the present invention.

### BRIEF DESCRIPTION OF THE DRAWINGS

FIG. 1 is an exemplary diagram showing a cross sectional view of a hard coat film of the present invention.

FIG. 2 is an exemplary diagram showing a cross sectional view of a polarizing plate employing a hard coat film of the present invention.

FIG. 3 is an exemplary diagram showing a cross sectional view of a transmission type LCD of the present invention.

FIG. 4 is an exemplary diagram showing a coating system employing a die coater of the present invention.

### DESCRIPTION OF REFERENCE NUMERALS AND SIGNS

1: Hard coat film
11: Film substrate
12: Hard coat layer
2: Polarizing plate
21: Film substrate
22: Polarizing layer
3: Polarizing plate
4: Liquid crystal cell
5: Backlight unit
60: Die head
61: Pipework
62: Tank of coating liquid
63: Liquid transfer pump
65: Rotary roll

### DETAILED DESCRIPTION OF THE INVENTION

The coating liquid for forming a hard coat layer, a hard coat film, a polarizing plate and LCD of the present invention is described below.

It is a feature of the coating liquid for forming a hard coat layer of the present invention that at least an ionizing radiation curing material, a fluorosurfactant or silicone surfactant, and a solvent is included and a weight mean solubility parameter δ of the component other than the solvent component and the surfactant component in the coating liquid for forming a hard coat layer is 21.5 or more.

The inventor fabricated a hard coat film having excellent antifouling properties with low cost by using the coating liquid for forming a hard coat layer which has more than 21.5 of the weight mean solubility parameter δ of the component other than the solvent component and the surfactant component in the coating liquid for forming a hard coat layer.

The hard coat layer of the present invention has antifouling properties owing to the fluorosurfactant or silicone surfactant contained in the coating liquid for forming a hard coat layer. A compound having a perfluoroalkyl group is used as the fluorosurfactant which is contained in the hard coat layer as a surfactant. A derivative having a basic structure of polydimethylsiloxane and a modified side chain is used the silicone surfactant.

The surfactant is also called a leveling agent, antifoam, an interfacial tension conditioner or a surface tension conditioner etc. depending on its function. The fluorosurfactant or the silicone surfactant contained in the coating liquid for forming a hard coat layer aims at decreasing the surface tension of the coating liquid when coated so that no coating defects such as repellency and unevenness etc. are produced along with providing the coated layer with antifouling properties.

It is necessary to concentrate the fluorosurfactant or the silicone surfactant within the surface region of the hard coat layer in order to achieve a high level of antifouling properties. The inventor succeeded in concentrating the fluorosurfactant or the silicone surfactant within the surface of the hard coat layer by adjusting a weight mean solubility parameter δ of the component other than the solvent component and the surfactant component in the coating liquid for forming a hard coat layer to 21.5 or more. The present invention requires a smaller amount of fluorosurfactant or silicone surfactant because the present invention enables the fluorosurfactant or silicone surfactant to be concentrated within the surface of the hard coat layer. It is possible to form the hard coat layer with low cost by using the coating liquid for forming a hard coat layer of the present invention because the fluorosurfactant and silicone surfactant are expensive. In addition, in the case where the hard coat layer is formed using too much fluorosurfactant or silicone surfactant, sometimes a sufficient abrasion resistance is not obtained. Thus, it is possible to prevent the decrease in abrasion resistance by using the present invention, which requires a smaller amount of fluorosurfactant or silicone surfactant usage.

The weight mean solubility parameter δ of the component other than the solvent component and the surfactant component in the coating liquid for forming a hard coat layer refers to a weight average of all solubility parameters of corresponding components.

The solubility parameter is defined as a resultant force of all intermolecular attractive forces and experimentally relates to mutual solubility between a number of chemical species. Fedors' method, Hansen's method and Small's method etc. are examples of a calculating method of the solubility parameter. The solubility parameter is calculated by the Fedors' method in the present invention (cf. Polymer Engineering and Science, vol. 14, p. 147 (1974)). In this method, the solubility parameter δ [(cal/cm³)^{1/2}] of each component can be derived from the energy of evaporation Δeᵢ and the molar volume Δvᵢ according to the <formula 1> below.

δ=(ΣΔeᵢ/ΣΔvᵢ)^{1/2} formula (1)

Then, using the resultant solubility parameter of each component, a weight average can be calculated to obtain the weight mean solubility parameter.

In addition, it is preferred in the coating liquid for forming a hard coat layer of the present invention that the weight mean solubility parameter δ of the components other than the fluorosurfactant component or the silicone surfactant component is 19.0 or more.

The fluorosurfactant or the silicone surfactant is efficiently concentrated within the hard coat layer surface by adjusting the weight mean solubility parameter δ of the components other than the solvent component and the surfactant component to 21.5 or more, and further, adjusting the weight mean solubility parameter δ of the components other than the surfactant component to 19.0 or more. As a result, it is possible to provide the resultant hard coat layer with a high level of antifouling properties.

In addition, it is preferable that the fluorosurfactant or the silicone surfactant in the coating liquid of the present invention is a cross-linking type surfactant. The cross-linking type surfactant is a surfactant which has a carbon-carbon unsaturated double bond in the molecule. The cross-linking type surfactant makes a chemical bond to the ionizing radiation curing material when the coating liquid cures so that the surfactant seldom drops off from the hard coat layer and the hard coat layer keeps a high level of antifouling properties for a long period. Moreover, even if the surface is scrubbed with a cloth etc., the hard coat layer does not lose the antifouling properties.

The coating liquid for forming a hard coat layer is preferred to include the fluorosurfactant or the silicone surfactant by a ratio in the 0.005-1.000 parts by weight range relative to 100 parts by weight of solid contents of the coating liquid, which are the components of the coating liquid except for the solvent component. If the content of the fluorosurfactant or the silicone surfactant is less than 0.005 parts by weight, the hard coat layer may have insufficient antifouling properties. Meanwhile, if the content of the fluorosurfactant or the silicone surfactant is more than 1.000 parts by weight, the usage of the surfactant is so much that the hard coat layer costs too high. In addition, if the content of the fluorosurfactant or the silicone surfactant is more than 1.000 parts by weight, the abrasion resistance of the hard coat layer may become insufficient. The coating liquid for forming a hard coat layer of the present invention enables the hard coat layer to have high antifouling properties on the surface even though the content of the fluorosurfactant or the silicone surfactant is 1.000 or less parts by weight.

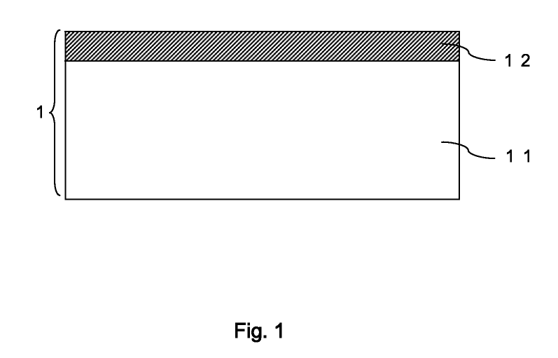

FIG. 1 illustrates an exemplary diagram of a cross sectional view of a hard coat film formed by using the coating liquid for forming a hard coat layer of the present invention. The hard coat film 1 of the present invention has a hard coat layer 12 on a film substrate 11. The hard coat layer 12 is formed by a process for coating the coating liquid for forming a hard coat layer on a film substrate, a process for drying the coated film to remove the solvent, and a process for exposing the coated film to ionizing radiation to cure. It is a feature of the coating liquid for forming a hard coat layer of the present invention that the coating liquid includes at least an ionizing radiation curing material, a fluorosurfactant or a silicone surfactant, and a solvent, and the weight mean solubility parameter δ of the coating liquid components other than the solvent component and the surfactant component is 21.5 or more. In addition, the weight mean solubility parameter δ of the coating liquid components other than the surfactant component is 19.0 or more. Moreover, the fluorosurfactant or the silicone surfactant is a cross-linking type surfactant. Furthermore, the coating liquid is preferred to include 0.005-1.000 parts by weight of the fluorosurfactant or the silicone surfactant relative to 100 parts by weight of the coating liquid components excluding the solvent component.

The hard coat film of the present invention may include other functional layers between the hard coat layer 12 and film substrate 11, or on the other surface of the film substrate from the hard coat layer 12. A functional layer which has antistatic properties, electromagnetic shielding properties, infrared absorbing properties, ultraviolet absorbing properties, color compensation properties, polarizing properties, hard coat properties, cushioning properties or antiglare properties etc. can be arranged within the hard coat film. In other words, an antistatic layer, an antifouling layer, an electromagnetic shielding layer, an infrared absorbing layer, an ultraviolet absorbing layer, a color compensation layer, a polarizing layer, a hard coat layer, a cushioning layer or an antiglare layer etc. can be formed as a functional layer. A plurality of functional layers may also be formed.

The surface of the hard coat film of the present invention is preferred to have contact angles more than 90° with water, more than 65° with diiodemethane and more than 35° with hexadecane. If the hard coat film has contact angles more than 90° with water, more than 65° with diiodemethane and more than 35° with hexadecane, the hard coat film obtains a high level of antifouling properties.

In addition, the hard coat film of the present invention is preferred to have a hard coat layer with a thickness in the range of 4-25 μm. In the case where the thickness is less than 4 μm, it may be hard for the hard coat layer to have a sufficient abrasion resistance. Meanwhile, in the case where the thickness is more than 25 μm, the hard coat film may lack sufficient handling ability during manufacturing since the hard coat film may curl too much due to shrinking accompanied by hardening. In addition, it may be difficult to attach the hard coat film on a predetermined device although the hard coat film is supposed to be attached on the device when using.

The hard coat film of the present invention is preferably applied on a display device such as an LCD, a PDP display, an FED and an electroluminescence display etc. or a touch panel.

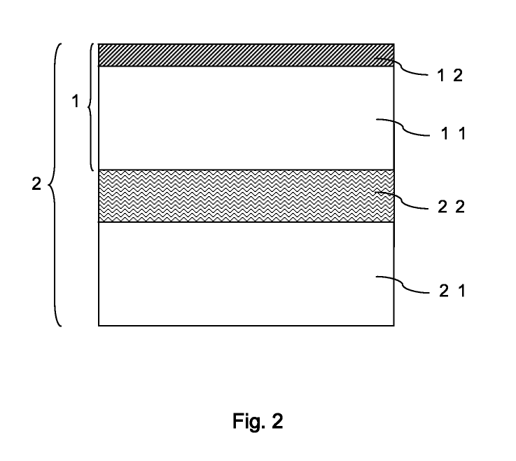

FIG. 2 shows an exemplary cross section diagram of a polarizing plate using a hard coat film of the present invention. The polarizing plate of the present invention includes a hard coat film 1 which has a hard coat layer 12 on one surface of the film substrate 11 and a polarizing layer 22 along with another film substrate 21 on the opposite surface of the film substrate 11 from the hard coat layer 12.

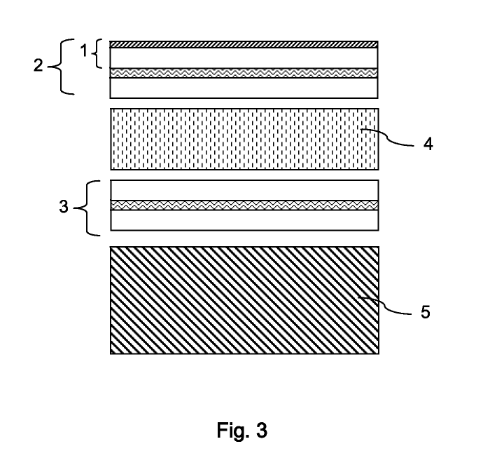

FIG. 3 shows an exemplary cross section diagram of a transmission type LCD using a polarizing plate of the present invention. The LCD includes a polarizing plate 2 which has a hard coat film 1 of the present invention, a liquid crystal cell 4, a polarizing plate 3 and a backlight unit 5. The surface of the transmission type LCD obtains excellent abrasion resistance and a high level of antifouling properties by forming a hard coat layer using a coating liquid for forming a hard coat layer.

Next, materials which are used for the coating liquid for forming a hard coat layer of the present invention will be described. The coating liquid for forming a hard coat layer contains at least an ionizing radiation curable type material, fluorosurfactant or silicone surfactant, and a solvent.

A polyfunctional acrylate (or methacrylate) which has a plurality of (particularly, three or more is preferable) acrylic groups or methacrylic groups in a single molecule and cures by ionizing radiation can be used as the ionizing radiation curable type material. Practically, polyol polyacrylate such as trimethylolpropane triacrylate (or trimethacrylate), ditrimethylolpropane tetraacrylate (or tetramethacrylate), pentaerythritol tetraacrylate (or tetramethacrylate), pentaerythritol triacrylate (or trimethacrylate), pentaerythritol diacrylate (or dimethacrylate), dipentaerythritol hexaacrylate (or hexamethacrylate), dipentaerythritol pentaacrylate (or pentamethacrylate) and dipentaerythritol tetraacrylate (or tetramethacrylate) etc., urethane acrylate (or methacrylate), which is obtained by a reaction of polyol, polyvalent isocyanate and acrylate (or methacrylate) having a hydroxyl group, polyester acrylate (or methacrylate), which is obtained by esterifying a polyol with a polyvalent carboxylic acid and/or its anhydride compound, and polysiloxane polyacrylate etc. are examples.

An acrylate (or methacrylate) means both an acrylate and methacrylate in the present invention. For example, trimethylolpropane triacrylate (or trimethacrylate) means both trimethylolpropane triacrylate and trimethylolpropane trimethacrylate.

Both a single kind of polyfunctional acrylate (or methacrylate) and any combination of a plurality of kinds of polyfunctional acrylates (or methacrylates) can be used as the polyfunctional acrylate (or methacrylate). The content of the acrylate (or methacrylate) is preferably in the range of 50-100 parts by weight relative to 100 parts by weight of solid content of the coating liquid except for the surfactant. In the case where the content of the acrylate (or methacrylate) is less than 50 parts by weight, the hard coat layer tends to have insufficient hardness and needs to have a thicker layer to obtain sufficient hardness, which may increase costs.

In addition, the polyfunctional acrylate (or methacrylate) shrinks when curing. Thus, after the coating liquid for forming a hard coat layer is coated on the film, dried and cured, the obtained hard coat film may be curled to such an extent that treating the film becomes difficult. Thus, if necessary, non-polymerizable polymer (polymerizably non-reactive polymer, which for example includes a non-reactive component such as PMMA (polymethyl methacrylate) etc.) and polymerizable polymer (polymerizably reactive polymer) having an acrylic group (or methacrylic group) can be added to the coating liquid in order to control the degree of shrinkage. The content of the non-polymerizable polymer and polymerizable polymer is preferably 50 or less parts by weight relative to 100 parts by weight of the solid content of the coating liquid except for the surfactant. If the non-polymerizable polymer and polymerizable polymer is more than 50 parts by weight relative to 100 parts by weight of the solid content of the coating liquid except for the surfactant, the hard coat layer tends to have insufficient hardness and needs to have a thicker layer to obtain sufficient hardness, which may increase the cost. In addition, if the non-polymerizable polymer and polymerizable polymer is more than 50 parts by weight, the viscosity of the polymer is so high that it becomes difficult to coat the coating liquid evenly.

Methyl isobutyl ketone, cyclohexanone, acetone, methyl ethyl ketone, diethyl ketone, dipropyl ketone, cyclopentanone, methylcyclohexanone, ethylcyclohexanone, 2-butanone, ethyl formate, propyl formate, n-pentyl formate, methyl acetate, ethyl acetate, methyl propionate, ethyl propionate, n-pentyl acetate, γ-butyrolactone, isobutyl acetate, butyl acetate, toluene, xylene, 2-propanol, 1-butanol, cyclopentanol, diaceton alcohol, ethylene glycol monomethyl ether, propylene glycol monomethyl ether, dibutyl ether, dimethoxymethane, dimethoxyethane, diethoxyethane, propylene oxide, dioxane, dioxolane, trioxane, tetrahydrofuran, anisole, phenetol, methyl cellosolve, cellosolve, butyl cellosolve, cellosolve acetate, dichloromethane, trichloromethane, trichloroethylene, ethylene chloride, trichloroethane, tetrachloroethane, N,N-dimethylformamide and chloroform etc. can be used as the solvent of the coating liquid for forming a hard coat layer of the present invention. The solvent does not have to be made of a single kind of solvent. The solvent may also be a mixture of a plurality of solvents. The viscosity of the coating liquid can be adjusted by adding the solvent to the coating liquid for forming a hard coat layer.

In the case where triacetyl cellulose (TAC), which suits well to an LCD, is used as the substrate film on which the coating liquid for forming a hard coat layer is coated and the hard coat layer is directly formed on the TAC film, it is preferable in the present invention that a mixture solvent of a solvent in which the TAC film is dissolved or swollen and a solvent in which the TAC film is not dissolved or swollen are used. The hard coat film can obtain sufficient adhesiveness on the interface between the TAC film and the hard coat layer by using the mixture solvent of a solvent in which the TAC film is dissolved or swollen and a solvent in which the TAC film is not dissolved or swollen.

At this time, ethers such as dibutyl ether, dimethoxymethane, dimethoxyethane, diethoxyethane, propylene oxide, dioxane, dioxolane, trioxane, tetrahydrofuran, anisole and phenetol etc., some ketones such as acetone, methyl ethyl ketone, diethyl ketone, dipropyl ketone, diisobutyl ketone, cyclopentanone, cyclohexanone and methylcyclohexanone etc., esters such as ethyl formate, propyl formate, n-pentyl formate, methyl acetate, ethyl acetate, methyl propionate, ethyl propionate, n-pentyl acetate and γ-butyrolactone etc., cellosolves such as methyl cellosolve, cellosolve, butyl cellosolve and cellosolve acetate etc. are examples of the solvent in which the TAC film is dissolved or swollen. Both a single solvent of these and a mixture solvent of these may be used.

Meanwhile, aromatic hydrocarbons such as toluene, xylene, cyclohexane and cyclohexylbenzene etc., aliphatic hydrocarbons such as n-hexane, some ketones such as methyl isobutyl ketone and methyl butyl ketone are examples of the solvent in which the TAC film is not dissolved or swollen. Both a single solvent of these and a mixture solvent of these may be used.

The coating liquid for forming a hard coat layer contains a fluorosurfactant or a silicone surfactant. Compounds having a perfluoroalkyl group can be used as the fluorosurfactant. Derivative compounds based on polydimethylsiloxane in which the side chain is modified can be used as the silicone surfactant. These fluorosurfactant and silicone surfactant are preferred to have a carbon-carbon unsaturated double bond in the molecule. It is possible to make it difficult for the surfactant to drop off from the hard coat layer by using a surfactant which has a cross-linked structure along with a carbon-carbon unsaturated double bond and reacting the surfactant with the acrylic (or methacrylic) group of the ionizing radiation curing material to make a chemical bond between them and form a matrix when curing the coating liquid for forming a hard coat layer.

In addition, other additives may be added to the coating liquid for forming a hard coat layer of the present invention. An antistat, an ultraviolet absorber, an infrared absorber, a refractive index adjuster, an adhesiveness improver, a curing agent and/or another surfactant etc. can be used as the other additives. In addition, it is possible to add particles to the coating liquid for forming a hard coat layer to produce concavities and convexities on the surface of the hard coat layer and provide the hard coat layer with an antiglare function. In other words, it is possible to prevent glare of a reflection image falling in the film surface by adding the particles to the hard coat layer to form concavities and convexities on the film surface. It is also possible to prevent glare of a display image and weaken color change and tone change observed in an oblique direction, which are specific to an LCD, by diffusing transmitted light using particles which have a significant difference with the hard coat material in refractive index.

In addition, in the case where ultraviolet light is used as the ionizing radiation to cure the ionizing radiation curable material, a light polymerization initiator is added to the coating liquid for forming a hard coat layer. Although any heretofore known light polymerization initiators can be used as the light polymerization initiator, it is preferred to use a light polymerization initiator which is well suited with the ionizing radiation curing material. Acetophenones, benzophenones, α-hydroxyketones, benzyl dimethyl ketal, α-aminoketones and/or acylphosphine oxides etc. is preferred to be used as the light polymerization initiator.

The usage of the light polymerization initiator is preferred to be in the range of 0.5-20 parts by weight against 100 parts by weight of the ionizing radiation curable material. To be more precise, in the range of 1-5 parts by weight is more preferable.

The hard coat film of the present invention will be described below. The hard coat film of the present invention has a hard coat layer on at least one surface of the film substrate and manufactured by forming a coated layer by coating the coating liquid for forming a hard coat layer on the substrate film, drying the coated layer to remove the solvent, and curing the coated layer by an exposure to ionizing radiation.

At this point, a glass or plastic film can be used as the film substrate. The plastic film is preferred to have an appropriate transparency and mechanical strength. For example, a film of polyethylene terephthalate (PET), triacetyl cellulose (TAC), diacetyl cellulose, acetylcellulose butylate, polyethylene naphthalate (PEN), cycloolefin polymer, polyimide, polyethersulfone (PES), polymethyl methacrylate (PMMA) or polycarbonate (PC) etc. can be used as the plastic film. Among these, in the case where the hard coat film is applied on a frontal surface of an LCD, TAC is preferably used because of the optical isotropy.

The coating liquid for forming a hard coat layer is coated on the film substrate to form a coated layer. A dip coating method, a spin coating method, a flow coating method, a spray coating method, a roll coating method, a gravure roll coating method, an air doctor coating method, a blade coating method, a wire doctor coating method, a knife coating method, a reverse coating method, a transfer roll coating method, a bar coating method, a micro gravure coating method, a kiss coating method, a cast coating method, a slit orifice coating method, a calendar coating method or a die coating method etc. can be used as the method for coating on the film substrate.

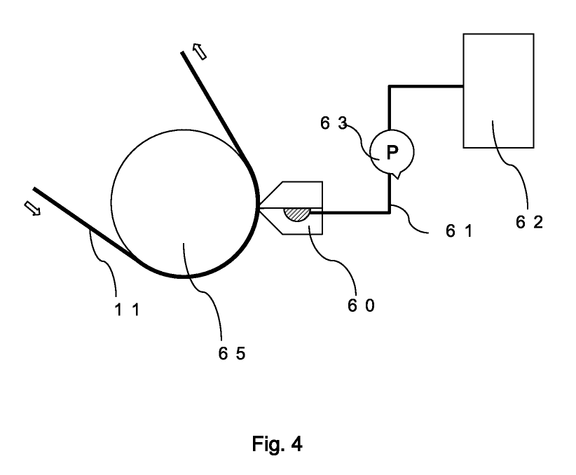

An exemplary diagram of the die coating machine of the present invention is showed in FIG. 4. The die coating machine of the present invention has a die head 60 and a tank of coating liquid 62 connected together with a pipework 61 so that the coating liquid for forming a hard coat layer in the tank of coating liquid 62 is delivered into the die head 60 by a liquid transfer pump 63. The coating liquid for forming a hard coat layer delivered to the die head 60 is spat up from a slit and a coated layer is produced on the film substrate 11. The coated layer can be continuously formed in a roll-to-roll system by using a wind-up film substrate 11 and rotary roll 65.

The coated layer formed on the film substrate by coating the coating liquid for forming a hard coat layer is dried so that the solvent is removed. The solvent within the coated film is removed by this drying. Heating, sending air or hot air are examples of the drying process. In addition, as the drying process the coated layer might be merely kept at room temperature under ordinary pressure.

Subsequently, the coated film on the film substrate is cured by an exposure to ionizing radiation. Ultraviolet light, electron beam or gamma ray can be used as the ionizing radiation. In the case where the electron beam or gamma ray is used as the ionizing radiation, it is unnecessary for the coating liquid for forming a hard coat layer to contain a photopolymerization initiator or a photopolymerization initiating adjuvant. In the case where ultraviolet light is used, a low pressure mercury lamp, a medium pressure mercury lamp, a high pressure mercury lamp, carbon arc a metal halide lamp, xenon lamp or an electrodeless discharge tube can be used as a light source. In the case where electron beams are used, electron beams from various electron accelerators such as Cockcroft-Walton type, van de Graaff type, resonant transformer type, insulated core transformer type, linear type, dynamitron type or high frequency type can be used. The hard coat film of the present invention is formed as described above. In addition, if the hard coat film is manufactured by a roll-to-roll system illustrated in FIG. 4, the film substrate may be sent to a coating unit, a drying unit, and an exposing to ionizing radiation unit continuously.

Next, a polarizing plate and a transmission type LCD of the present invention are explained. A conventional polarizing layer can be used as the polarizing layer of the polarizing plate of the present invention. An example of the polarizing layer is a stretched polyvinyl alcohol (PVA) film to which iodine is added. A polarizing plate can be produced by arranging the polarizing layer between the hard coat film of the present invention and a film substrate. The same film substrate as that of the hard coat layer of the present invention can be used as the film substrate herein. In particular, a TAC film is preferable.

A conventional liquid crystal cell, the other polarizing plate and backlight unit can also be used as the liquid crystal cell, the other polarizing plate and the backlight unit of the present invention. In addition, the transmission type LCD may include other functional components. For example, a diffusion film, a prism sheet and/or a luminance improving film, which serves to utilize light from the backlight unit efficiently, and retardation film, which compensates for the difference in an optical phase caused by the liquid crystal cell and/or the polarizing plates, are available although the present invention is not limited to them.

### EXAMPLES

Examples of the present invention are described below.

A TAC film, TD-80U (manufactured by Fuji Photo Film Corp.) was used as the film substrate. The coating liquids were prepared in Examples 1-7 and Comparative examples 1-3, respectively, using surfactants shown in table 1, ionizing radiation curable materials and photopolymerization initiators shown in table 2 and solvents shown in table 3.

The coating liquids for forming a hard coat layer in Examples 1-7 and Comparative examples 1-3 obtained as noted above were coated on the TAC films by a coating machine employing a die coater. After dried to remove solvents remaining in the coated layers, the coated layers were cured by exposure to 400 mJ/cm² of ultraviolet light using a high pressure mercury lamp under an atmosphere of oxygen concentration less then (or equal to) 0.03% and thus the hard coat films were fabricated.

TABLE 1

| | | | Parts by |
|---|---|---|---|
| | | | weight |
| Example 1 | Cross-linking | MEGAFACE RS101K | 0.1 |
| | fluorosurfactant | (made by DIC Corp.) | |
| Example 2 | Cross-linking | MEGAFACE RS101K | 0.1 |
| | fluorosurfactant | (made by DIC Corp.) | |
| Example 3 | Cross-linking | OPTOOL DAC (made by | 0.1 |
| | fluorosurfactant | Daikin Industries) | |
| Example 4 | Cross-linking | OPTOOL DAC (made by | 0.1 |
| | fluorosurfactant | Daikin Industries) | |
| Example 5 | Cross-linking | OPTOOL DAC (made by | 0.1 |
| | fluorosurfactant | Daikin Industries) | |
| Example 6 | Cross-linking silicone | BYK-UV3500 (made by | 0.1 |
| | surfactant | BYK-Chemie Japan) | |
| Example 7 | Cross-linking | OPTOOL DAC (made by | 2.0 |
| | fluorosurfactant | Daikin Industries) | |
| Comparative | Cross-linking acrylic | UCR-L93 (made by | 0.1 |
| example 1 | surfactant | Kyoeisha Chemical | |
| | | Co., Ltd.) | |
| Comparative | Cross-linking | MEGAFACE RS101K | 0.1 |
| example 2 | fluorosurfactant | (made by DIC Corp.) | |
| Comparative | Cross-linking | MEGAFACE RS101K | 0.1 |
| example 3 | fluorosurfactant | (made by DIC Corp.) | |

TABLE 2

| | | | Parts by | Solubility |
|---|---|---|---|---|
| | | | weight | parameter δ |
| Example 1 | Ionizing radiation | PE-3A (made by Kyoeisha | 70.0 | 23.6 |
| | curable material | Chemical Co., Ltd.) | | |
| | | UA-510I (made by Kyoeisha | 24.9 | 21.6 |
| | | Chemical Co., Ltd.) | | |
| | Photopolymerization | Irgacure 184 (made by Ciba | 5.0 | 24.6 |
| | initiator | Specialty Chemicals) | | |
| Example 2 | Ionizing radiation | PE-3A (made by Kyoeisha | 30.0 | 23.6 |
| | curable material | Chemical Co., Ltd.) | | |
| | | UA-306I (made by Kyoeisha | 64.9 | 21.7 |
| | | Chemical Co., Ltd.) | | |
| | Photopolymerization | Irgacure 184 (made by Ciba | 5.0 | 24.6 |
| | initiator | Specialty Chemicals) | | |
| Example 3 | Ionizing radiation | PE-3A (made by Kyoeisha | 30.0 | 23.6 |
| | curable material | Chemical Co., Ltd.) | | |
| | | UA-306I (made by Kyoeisha | 64.9 | 21.7 |
| | | Chemical Co., Ltd.) | | |
| | Photopolymerization | Darocur 1173 (made by Ciba | 5.0 | 24.8 |
| | initiator | Specialty Chemicals) | | |
| Example 4 | Ionizing radiation | UA-306I (made by Kyoeisha | 94.9 | 21.7 |
| | curable material | Chemical Co., Ltd.) | | |
| | Photopolymerization | UA-306I (made by Kyoeisha | 5.0 | 24.8 |
| | initiator | Chemical Co., Ltd.) | | |
| Example 5 | Ionizing radiation | PE-3A (made by Kyoeisha | 10.0 | 23.6 |
| | curable material | Chemical Co., Ltd.) | | |
| | | UA-510I (made by Kyoeisha | 84.9 | 21.6 |
| | | Chemical Co., Ltd.) | | |
| | Photopolymerization | Irgacure 184 (made by Ciba | 5.0 | 24.6 |
| | initiator | Specialty Chemicals) | | |
| Example 6 | Ionizing radiation | PE-3A (made by Kyoeisha | 70.0 | 23.6 |
| | curable material | Chemical Co., Ltd.) | | |
| | | UA-510I (made by Kyoeisha | 24.9 | 21.6 |
| | | Chemical Co., Ltd.) | | |
| | Photopolymerization | Irgacure 184 (made by Ciba | 5.0 | 24.6 |
| | initiator | Specialty Chemicals) | | |
| Example 7 | Ionizing radiation | PE-3A (made by Kyoeisha | 10.0 | 23.6 |
| | curable material | Chemical Co., Ltd.) | | |
| | | UA-510I (made by Kyoeisha | 83.0 | 21.6 |
| | | Chemical Co., Ltd.) | | |
| | Photopolymerization | Irgacure 184 (made by Ciba | 5.0 | 24.6 |
| | initiator | Specialty Chemicals) | | |
| Comparative | Ionizing radiation | PE-3A (made by Kyoeisha | 94.9 | 23.6 |
| example 1 | curable material | Chemical Co., Ltd.) | | |
| | Photopolymerization | Irgacure 184 (made by Ciba | 5.0 | 24.6 |
| | initiator | Specialty Chemicals) | | |
| Comparative | Ionizing radiation | PE-3A (made by Kyoeisha | 20.0 | 23.6 |
| example 2 | curable material | Chemical Co., Ltd.) | | |
| | | TMP-A (made by Kyoeisha | 74.9 | 20.2 |
| | | Chemical Co., Ltd.) | | |
| | Photopolymerization | Darocur 1173 (made by Ciba | 5.0 | 24.6 |
| | initiator | Specialty Chemicals) | | |
| Comparative | Ionizing radiation | PE-3A (made by Kyoeisha | 20.0 | 23.6 |
| example 3 | curable material | Chemical Co., Ltd.) | | |
| | | TMP-A (made by Kyoeisha | 74.9 | 20.2 |
| | | Chemical Co., Ltd.) | | |
| | Photopolymerization | Darocur 1173 (made by Ciba | 5.0 | 24.6 |
| | initiator | Specialty Chemicals) | | |

TABLE 3

| | | Parts by | Solubility |
|---|---|---|---|
| | | weight | parameter δ |
| Example 1 | Ethyl acetate | 100 | 17.9 |
| Example 2 | Ethyl acetate | 100 | 17.9 |
| Example 3 | Ethyl acetate | 100 | 17.9 |
| Example 4 | Ethyl acetate | 100 | 17.9 |
| Example 5 | MEK | 50 | 17.3 |
| | Methyl acetate | 50 | 18.0 |
| Example 6 | Ethyl acetate | 100 | 17.9 |
| Example 7 | Methyl ethyl ketone | 50 | 17.3 |
| | Methyl acetate | 50 | 18.0 |
| Comparative example 1 | Ethyl acetate | 100 | 17.9 |
| Comparative example 2 | Ethyl acetate | 100 | 17.9 |
| Comparative example 3 | Methyl acetate | 50 | 18.0 |
| | HFE-7100 | 50 | 12.4 |

The evaluations described below were performed on the hard coat films fabricated in Examples 1-7 and Comparative examples 1-3.

### Measurement of Contact Angle

Contact angles of water (pure water), diiodemethane or hexadecane were measured with a 1.5 mm-diameter droplet using a contact angle meter CA-X manufactured by Kyowa Interface Science Co., Ltd. at 23° C. under an atmosphere of 55% RH.

### Evaluation of Magic Ink (=an Oil Ink) Adhesion (Evaluation of Antifouling Properties)

A mark was written on a sample surface with an oil marker Makkie-super fine (made by ZEBRA Co., Ltd.) and was kept still for 30 seconds. Then, a degree of repelling was evaluated as follows.

### <Evaluation Criteria>

Double circle: The ink was heavily repelled so that the trail of ink appeared as a polka dotted pattern.
Circle: The ink was repelled so that a part of the ink trail appeared as a polka dotted pattern.
Triangle: Although the ink was slightly repelled, the trail of ink did not appear as a polka dotted pattern.
Cross: As the ink was not repelled, the trail of ink remained firmly.
Evaluation of Magic Ink (=an Oil Ink) Adhesion after a Scrubbing Test

An evaluation of magic ink (=an oil ink) adhesion after a scrubbing test was performed using a color fastness rubbing tester (manufactured by Tester Sangyo Co., Ltd.) under the following condition.

### <Scrubbing Test>

Environmental condition: At 25° C. and 60% RH.
Scrubbing material: Tissue paper (Nepia tissue paper made by Oji paper Co., Ltd.).
Shape of the scrubbing part: 1 cm×1 cm.
Scrubbing load: 500 grams-weight.
Amount of scrubbing: Reciprocating 500 laps.

### <Evaluation Criteria>

Double circle: The ink was heavily repelled so that the trail of ink appeared as a polka dotted pattern.
Circle: The ink was repelled so that a part of the ink trail appeared as a polka dotted pattern.
Triangle: Although the ink was slightly repelled, the trail of ink did not appear as a polka dotted pattern.
Cross: As the ink was not repelled, the trail of ink remained firmly.

### Antifouling Properties (Fingerprint Smears)

After the hard coat film was pressed by fingers so that the smears of the fingers were attached to the film, and kept still for 30 min., the film was wiped with a tissue paper (Nepia tissue paper made by Oji paper Co., Ltd.) and removability of the smears was evaluated. This was performed three times and the evaluation was made as the average.

### <Evaluation Criteria>

Double circle: The smear was removed by wiping of 5 or less reciprocating laps.
Circle: The smear was removed by wiping in the range of 6-10 reciprocating laps.
Triangle: The smear was removed by wiping in the range of 11-15 reciprocating laps.
Cross: The smear was not removed even after wiping of 15 reciprocating laps.

### Abrasion Resistance Evaluation

A scrubbing test was performed using a color fastness rubbing tester (manufactured by Tester Sangyo Co., Ltd.) under the following condition and changes in appearance were observed.

### <Scrubbing Test>

Environmental condition: At 25° C. and 60% RH.
Scrubbing material: Steel wool (Grade No. #0000 made by Nihon Steel Wool Co., Ltd.).
Shape of the scrubbing part: 1 cm×1 cm.
Scrubbing load: 500 grams-weight.
Amount of scrubbing: Reciprocating 500 laps.

### <Evaluation Criteria>

Circle: No changes in appearance were observed.
Triangle: Some slight but not remarkable changes in appearance were observed.
Cross: Remarkable changes in appearance were observed.

Table 4 shows the evaluation results of the hard coat films obtained in Examples 1-7 and Comparative examples 1-3. Table 4 also includes the weight mean solubility parameters δ of the ionizing radiation curable materials and photopolymerization initiators, which are obtained from the coating liquids for forming a hard coat layer by excluding the solvent component and the surfactant component. In addition, average film thicknesses of the hard coat layers measured with a film thickness meter are also shown.

TABLE 4

| | | | | Contact angle | | | | | | |
|---|---|---|---|---|---|---|---|---|---|---|
| | | | | | Diiode- | Hexa- | | | | |
| | <1> | <2> | <3> | Water | methane | decane | <4> | <5> | <6> | <7> |
| Example 1 | 23.1 | 20.5 | 12 μm | 101° | 70° | 49° | ◯ | ◯ | ◯ | ◯ |
| Example 2 | 22.4 | 20.1 | 12 μm | 99° | 69° | 47° | ◯ | ◯ | ◯ | ◯ |
| Example 3 | 22.4 | 20.2 | 12 μm | 107° | 80° | 55° | ⊚ | ⊚ | ⊚ | ◯ |
| Example 4 | 21.8 | 19.9 | 12 μm | 105° | 79° | 54° | ⊚ | ◯ | ⊚ | ◯ |
| Example 5 | 21.9 | 19.8 | 12 μm | 105° | 77° | 54° | ⊚ | ◯ | ⊚ | ◯ |
| Example 6 | 23.1 | 20.5 | 12 μm | 92° | 65° | 35° | ⊚ | ◯ | Δ | ◯ |
| Example 7 | 21.5 | 19.6 | 12 μm | 110° | 52° | 56° | ⊚ | ◯ | ⊚ | Δ |
| Comparative | 23.6 | 20.8 | 12 μm | 73° | 64° | 11° | X | X | X | ◯ |
| example 1 | | | | | | | | | | |
| Comparative | 21.1 | 19.5 | 12 μm | 88° | 64° | 35° | Δ | X | ◯ | ◯ |
| example 2 | | | | | | | | | | |
| Comparative | 21.1 | 18.1 | 12 μm | 89° | 80° | 32° | Δ | X | Δ | ◯ |
| example 3 | | | | | | | | | | |

<1>: Weight mean solubility parameter δ of the ionizing radiation curable material and the photopolymerization initiator.
<2>: Weight mean solubility parameter δ of the ionizing radiation curable material, the photopolymerization initiator and the solvent.
<3>: Thickness of the hard coat layer.
<4>: Magic ink (an oil ink) adhesion.
<5>: Magic ink (an oil ink) adhesion after a scrubbing test.
<6>: Antifouling properties (fingerprint smears).
<7>: Abrasion resistance.

It was confirmed that it was possible to form a hard coat layer having excellent antifouling properties with low costs by using the coating liquid for forming a hard coat layer in Examples 1-7.

What is claimed is:

1. A manufacturing method of a hard coat film, said hard coat film comprising:
a hard coat layer; and
a film substrate, said hard coat layer being arranged on at least one surface of said film substrate, and a fluorosufactant being concentrated within a surface of said hard coat layer, said method comprising:
coating a coating liquid for forming a hard coat layer on said film substrate to form a coated layer;
drying said coated layer; and
exposing said coated layer to ionizing radiation so that said coated layer cures, said coating liquid for forming a hard coat layer comprising:
a silicone surfactant;
a solvent; and
a first component including an ionizing radiation curable material, a weight mean solubility parameter δ of said first component being 21.5 or more, and said weight mean solubility parameter δ being in units of (cal/cm³)^{0.5}.

2. The manufacturing method according to claim 1, wherein said silicone surfactant is a cross-linking surfactant.

3. The manufacturing method according to claim 1, wherein 0.005-1 parts by weight of said silicone surfactant component is included in 100 parts by weight of said first component and said silicone surfactant.

4. A manufacturing method of a hard coat film, said hard coat film comprising:
a hard coat layer; and
a film substrate, said hard coat layer being arranged on at least one surface of said film substrate, and a fluorosufactant being concentrated within a surface of said hard coat layer, said method comprising:
coating a coating liquid for forming a hard coat layer on said film substrate to form a coated layer;
drying said coated layer; and
exposing said coated layer to ionizing radiation so that said coated layer cures, said coating liquid for forming a hard coat layer consisting of:
a fluorosurfactant;
a solvent; and
a first component including an ionizing radiation curable material, a weight mean solubility parameter δ of said first component being 21.5 or more, and said weight mean solubility parameter δ being in units of (cal/cm³)^{0.5}.

5. The manufacturing method according to claim 4, wherein a second component includes said first component and said solvent, and wherein a weight mean solubility parameter δ of said second component is 19.0 or more.

6. The manufacturing method according to claim 4, wherein said fluorosurfactant is a cross-linking surfactant.

7. The manufacturing method according to claim 4, wherein 0.005-1 parts by weight of said fluorosurfactant component is included in 100 parts by weight of said first component and said fluorosurfactant.

8. The manufacturing method according to claim 6, wherein 0.005-1 parts by weight of said fluorosurfactant component is included in 100 parts by weight of said first component and said fluorosurfactant.

9. The manufacturing method according to claim 4, wherein a contact angle of water is more than or equal to 90°, a contact angle of diiodemethane is more than or equal to 65°, and a contact angle of hexadecane is more than or equal to 35° on the surface of said hard coat layer.

10. The manufacturing method according to claim 8, wherein a contact angle of water is more than or equal to 90°, a contact angle of diiodemethane is more than or equal to 65°, and a contact angle of hexadecane is more than or equal to 35° on the surface of said hard coat layer.

11. The manufacturing method according to claim 4, wherein a thickness of said hard coat layer is in the range of 4-25 μm.

12. The manufacturing method according to claim 10, wherein a thickness of said hard coat layer is in the range of 4-25 μm.
